(19) United States
(12) Patent Application Publication
(10) Pub. No.: US 2004/0072532 A1
(43) Pub. Date: Apr. 15, 2004

(54) Vent assembly with drawer-type grill unit for automobiles

(76) Inventor: Sung-Ho Cho, Uiwang City (KR)

Correspondence Address: LEVINE & MANDELBAUM, 444 MADISON AVENUE, 35TH FLOOR, NEW YORK, NY, 10022, US

(21) Appl. No.: 10/467,558

(22) PCT Filed: Apr. 9, 2002
(86) PCT No.: PCT/KR02/00619

(30) Foreign Application Priority Data
Apr. 12, 2001 (KR) 2001/19619

(51) Int. Cl. B60H 1/34

(52) U.S. Cl. 454/155

(57) ABSTRACT

The object of this invention is to provide a vent assembly with a drawer-type grill unit for automobiles. This vent assembly “A” consists of a grill unit (1) and a housing (2) installed in the dashboard “B”. The grill unit (1) includes a grillwork (11), and a grillwork holder (10) holding the grillwork therein and integrated with a drawer part (12). The grill unit (1) is movably set in the housing (2) such that the unit is ejected from or retracted into the housing within a predetermined range by a sliding means. A stopper (16) is provided on the external surface of the drawer part, while a hook (21) is provided on the internal surface of the housing. The stopper (16) is stopped by the hook (21) when the grill unit is drawn out, and so the grill unit is prevented from an undesired complete removal from the housing.

### TECHNICAL FIELD

The present invention relates, in general, to vent assemblies used for discharging hot and cold air into the passenger compartment of an automobile for accomplishing an air conditioning effect for the passenger compartment and, more particularly, to a vent assembly for automobiles, which has a movable grill unit designed to be appropriately ejected from or retracted into a housing by a motor operation or a manual operation within a predetermined range capable of preventing an undesired complete removal of the grill unit from the housing, thus allowing a user to selectively eject or retract the grill unit from or into the housing, and which thus allows the user to open the housing when it is desired to clean the grill unit and the interior of the housing. This vent assembly also has a drawer part at the rear section of the grill unit to contain a desired material, such as an aromatic, in the drawer part, with an air filter removably seated in a seating slot of the grill unit, and so the vent assembly blows fresh, clean and scented air into the passenger compartment.

### BACKGROUND ART

As well known to those skilled in the art, most automobiles are typically provided with air conditioning apparatuses, such as heaters or air conditioners, for discharging impure air from the passenger compartment to the atmosphere and feeding fresh hot or cool air into the compartment. Such fresh air fed from such an air conditioning apparatus is blown into the passenger compartment through the grillwork of a vent assembly installed at a dashboard.

The grillwork of a conventional vent assembly, acting as the final path guiding the fresh hot or cool air into the passenger compartment, comprises a plurality of grating bars which have a blade shape and are movably set in a grill frame fixedly installed in the venting channel of a dashboard. Therefore, when it is desired to change the air blowing direction of the grillwork, the grating bars are manually tilted upward, downward, leftward or rightward at a limited angle within the fixed grill frame.

In such a conventional vent assembly for automobiles, the air blowing direction of the grillwork is limitedly controlled by manually tilting the blade-shaped grating bars in the fixed grill frame to a desired direction within a limited angular range. It is thus almost impossible to clean the interior of the venting channel in back of the grill frame, and so a great quantity of dust is deposited in the venting channel as time goes by after the production of an automobile. Such deposited dust is blown into the passenger compartment along with fresh hot or cool air during an operation of an air conditioning apparatus, such as a heater or an air conditioner, thus being bad for passengers' health, particularly, for passengers' respiratory organs, and causing several diseases in said organs. Furthermore, the conventional vent assembly does not allow an installation of an air filter at a position around it, and so most passengers, including a driver while driving an automobile, inevitably breathe dust-laden air blown from the grillwork.

In addition to the above-mentioned problems of difficulty in cleaning the interior of the venting channel or installing an air filter, another problem of the conventional vent assembly caused by an absence of any means for holding air quality enhancing agents, such as aromatics, germicides, and/or deodorizers, in the assembly. Such agents are thus laid on the top wall of the dashboard or the rear shelf provided in back of the rear seats inside the passenger compartment, or attached to the front of the grillwork such that air laden with components of the agents circulates in the passenger compartment. However, such installation of the agents makes the interior of the passenger compartment messy, as well as interfering with the safe driving of a driver.

In an effort to overcome the problems experienced in the conventional vent assembly with the fixed grill frame, there was proposed and has been used an interior vent nozzle for air conditioning apparatuses of automobiles in Japanese Utility Model Laid-open Publication No. Sho. 61-137,012. This vent nozzle, which corresponds to a grill frame with a grillwork and is referred to as “grill frame” herein below, is removably installed in a housing fixedly set in the dashboard of an automobile such that the grill frame with the grillwork is completely removed from the housing by pulling the grill frame from the housing when desired. That is, this grill frame has a detachable structure, which allows a user to install or remove the grill frame with the grillwork in or from the housing provided in the dashboard. However, due to such a detachable structure, this grill frame is not stably installed in the housing, and so it is undesirably moved in the housing to generate noises upsetting passengers around the grill frame when the automobile runs at speed with substantial vibrations. In addition, when the grill frame is repeatedly removed and installed from or in the housing, the assembling parts of both the grill frame and the housing may be damaged or broken, thus sometimes forcing the user to change the damaged or broken grill frame and/or housing with new ones. This grill frame is thus inconvenient to the user, and forces the user to pay excessive money for purchasing the new grill frame and/or housing. Another problem of the above grill frame resides in that it may be damaged or lost when it is completely removed from the housing and kept in the removed state for a period of time.

### DISCLOSURE OF THE INVENTION

Accordingly, the present invention has been made keeping in mind the above problems occurring in the prior art, and an object of the present invention is to provide a vent assembly for automobiles, which has a drawer-type movable grill unit designed to be appropriately ejected from or retracted into a housing in a horizontal direction by a motor operation or a manual operation within a predetermined range defined by stoppers provided on both the housing and the grill unit to prevent an undesired complete removal of the grill unit from the housing, thus allowing a user to selectively eject or retract the grill unit from or into the housing, and which thus allows the user to open the housing when it is desired to clean the grill unit and the interior of the housing, and which also has a drawer part at the rear section of the grill unit to contain a desired material, such as an aromatic, in the drawer part, with an air filter removably seated in a seating slot of the grill unit, and which thus blows fresh, clean and scented air into the passenger compartment.

In order to accomplish the above object, the present invention provides a vent assembly for automobiles, comprising a grill unit and a housing, wherein the grill unit consists of a grillwork, and a grillwork holder holding the grillwork therein and integrated with a drawer part, the grill unit being movably set in the housing such that the grill unit is ejected from or retracted into the housing within a predetermined range by sliding means, with a stopper provided on the external surface of the drawer part and a hook provided on the internal surface of the housing, whereby the stopper is stopped by the hook when the grill unit is ejected, and so the grill unit is prevented from an undesired complete removal from the housing.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is an exploded perspective view of a vent assembly for automobiles in accordance with the primary embodiment of the present invention;

FIG. 1b is a perspective view, showing an operation of the vent assembly according to the primary embodiment of this invention;

FIG. 2 is a side sectional view, showing the operation of the vent assembly according to the primary embodiment of this invention;

FIG. 3 is a perspective view of a vent assembly for automobiles in accordance with the second embodiment of the present invention;

FIG. 4 is a perspective view of a vent assembly having a seating slot in accordance with the third embodiment of the present invention;

FIG. 5a is a partially broken and exploded perspective view, showing a one-touch operation of a vent assembly in accordance with the fourth embodiment of the present invention;

FIG. 5b is a view corresponding to FIG. 5a, but showing a vent assembly in accordance with a modification of the fourth embodiment of this invention;

FIG. 5c is a side sectional view of a vent assembly in accordance with the fifth embodiment of the present invention; and

FIG. 6 is a perspective view, showing a vent assembly of this invention, which is installed at the dashboard of an automobile at a desired position.

### BEST MODE FOR CARRYING OUT THE INVENTION

Reference should now be made to the drawings, in which the same reference numerals are used throughout the different drawings to designate the same or similar components.

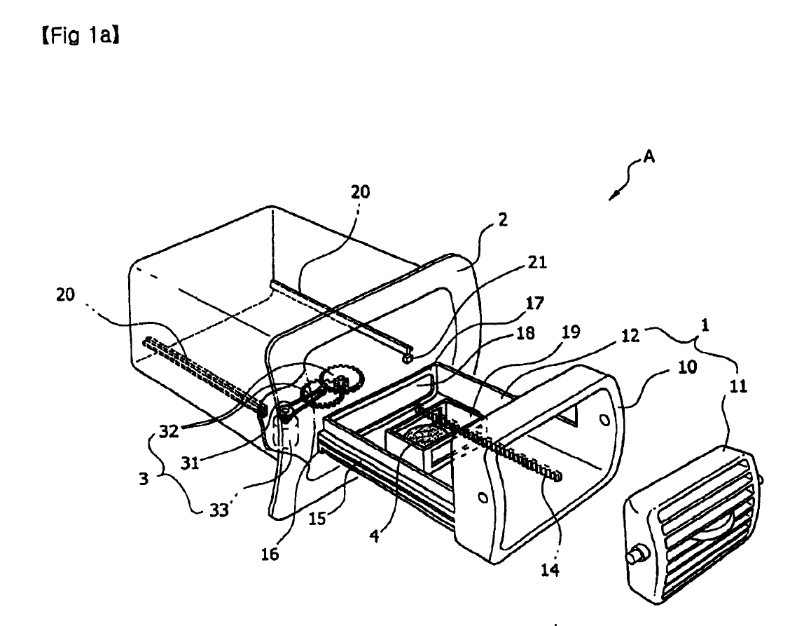

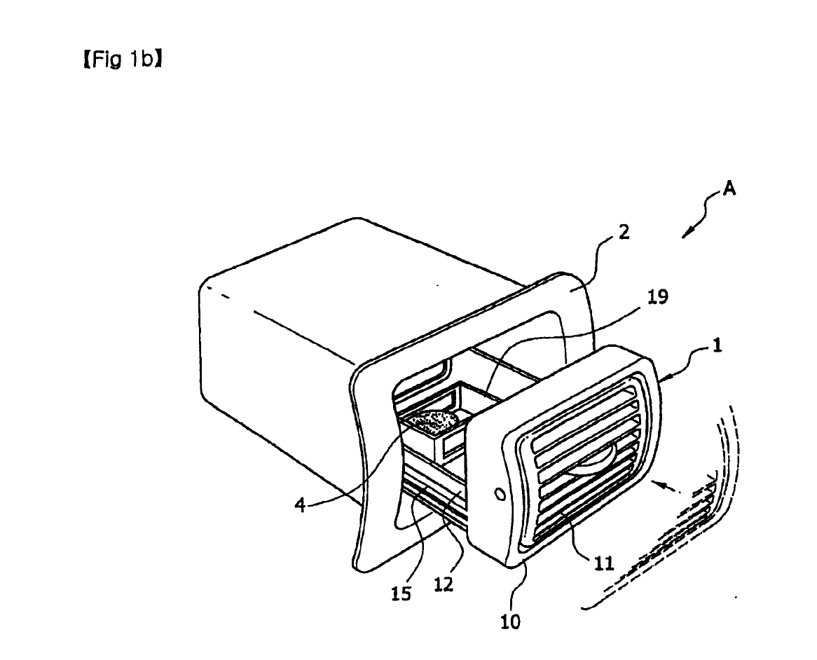

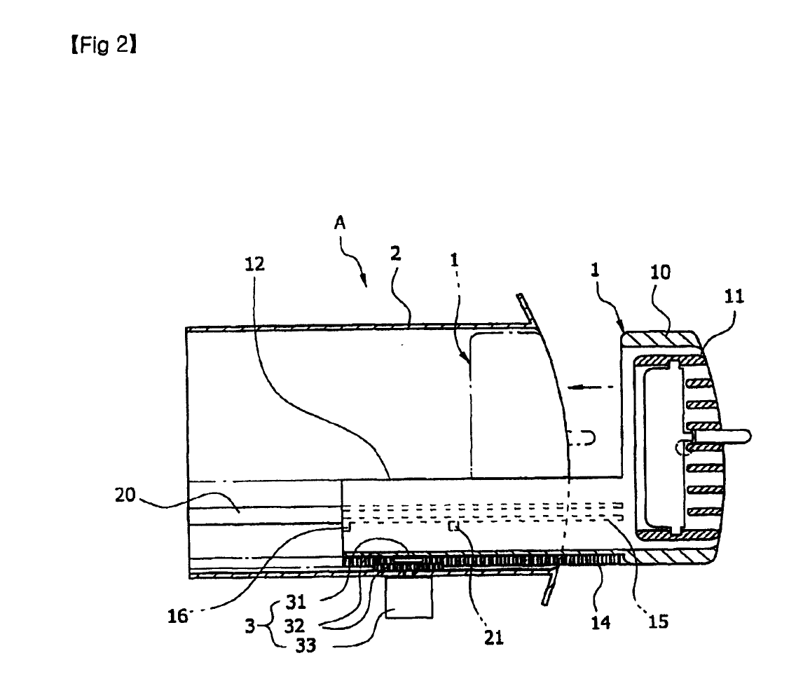

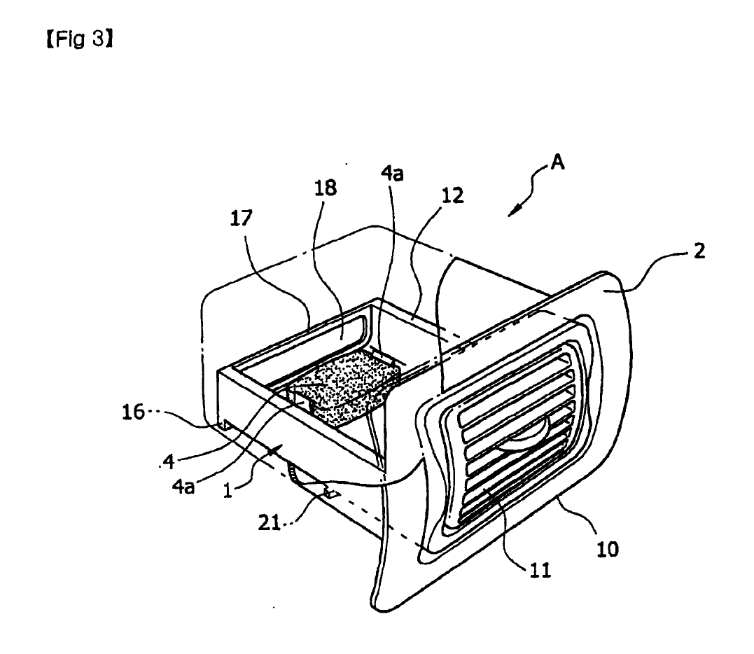

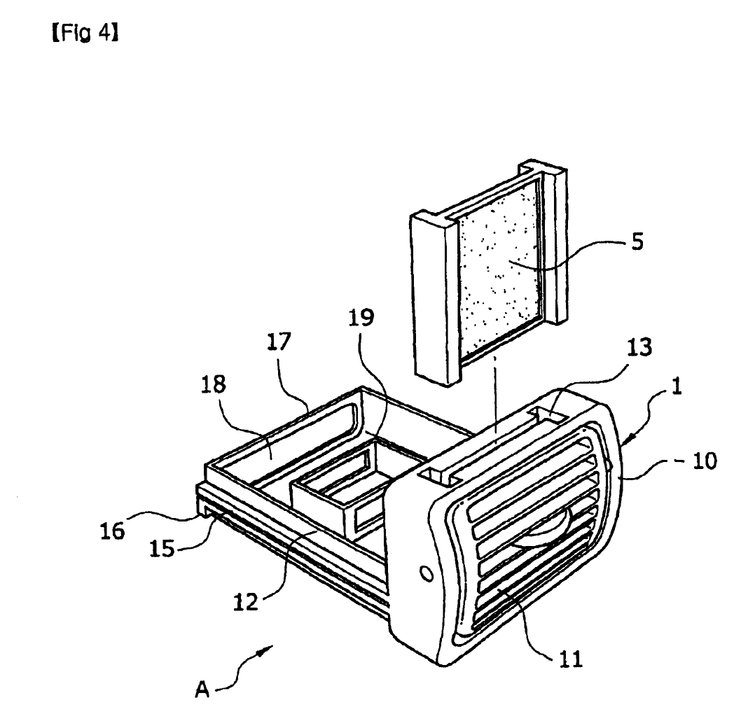

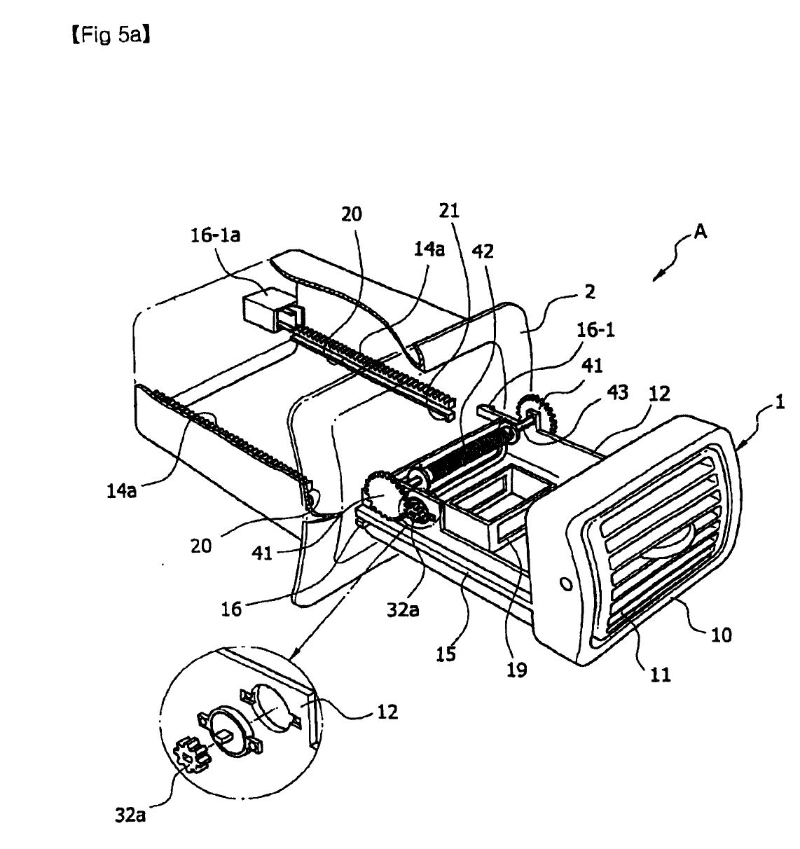

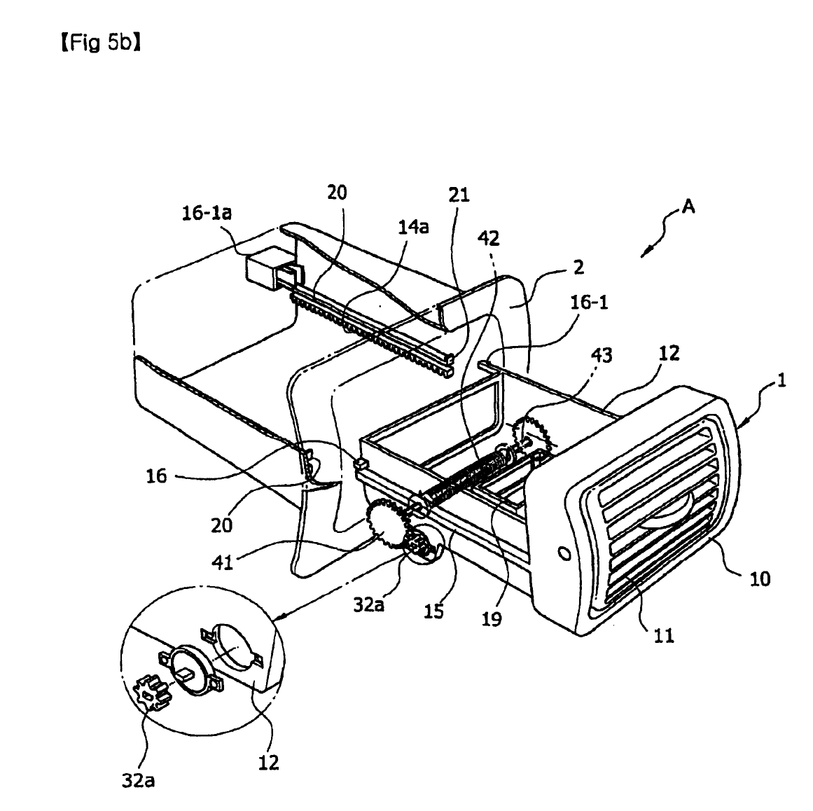

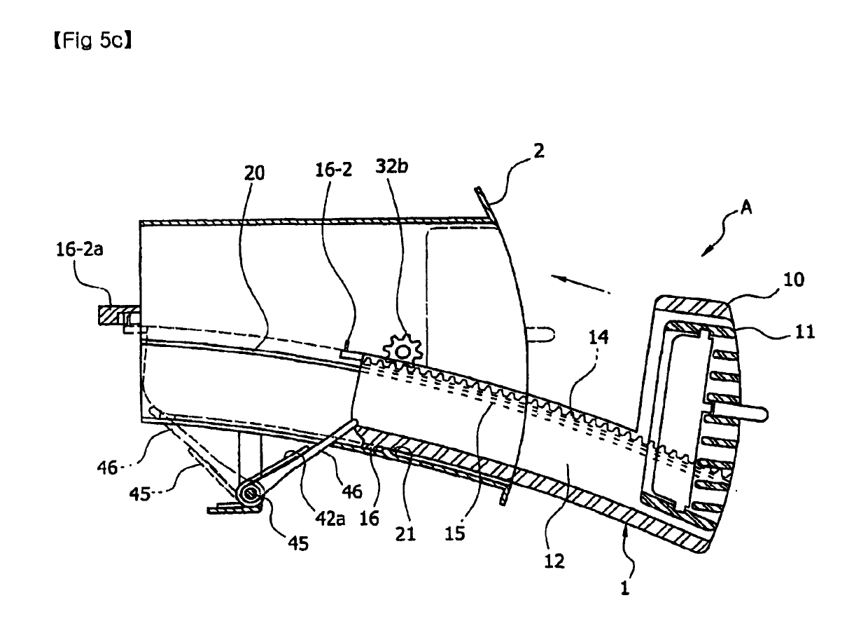

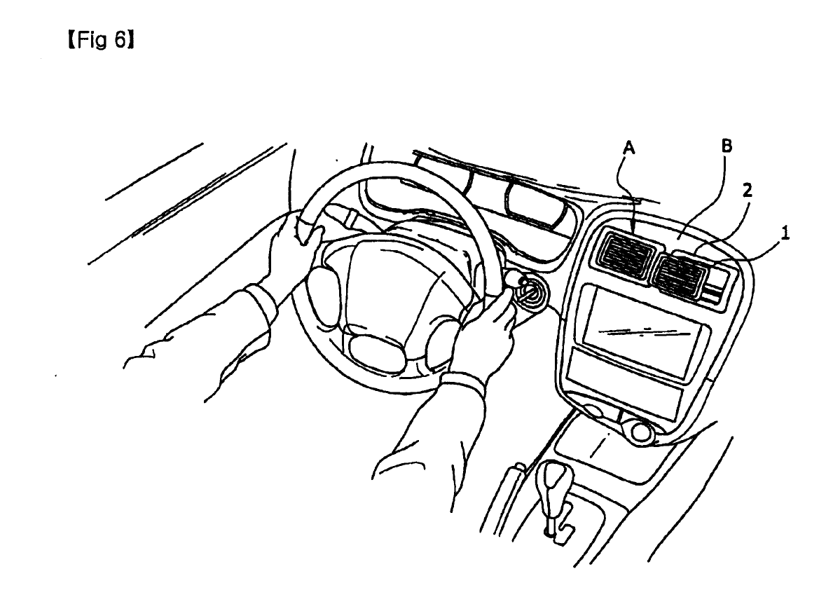

FIG. 1a is an exploded perspective view of a vent assembly for automobiles in accordance with the primary embodiment of this invention. FIG. 1b is a perspective view, showing an operation of the vent assembly according to the primary embodiment. FIG. 2 is a side sectional view, showing the operation of the vent assembly according to the primary embodiment. FIG. 3 is a perspective view of a vent assembly for automobiles in accordance with the second embodiment of this invention. FIG. 4 is a perspective view of a vent assembly having a seating slot in accordance with the third embodiment of this invention. FIG. 5a is a partially broken and exploded perspective view, showing a one-touch operation of a vent assembly in accordance with the fourth embodiment of this invention. FIG. 5b is a view corresponding to FIG. 5a, but showing a vent assembly in accordance with a modification of the fourth embodiment of this invention. FIG. 5c is a side sectional view of a vent assembly in accordance with the fifth embodiment of this invention. FIG. 6 is a perspective view, showing a vent assembly of this invention, which is installed at the dashboard of an automobile at a desired position. As shown in the drawings, the vent assembly for automobiles of this invention comprises a grill unit 1, a housing 2, and a sliding means for allowing the grill unit 1 to be moved relative to the housing 2 in opposite directions.

The grill unit 1 of the vent assembly according to the primary embodiment of this invention consists of a grillwork 11, and a grillwork holder 10 integrated with a drawer part 12 at the back thereof to form a grill frame. The grillwork holder 10 seats the grillwork 11 therein such that the grillwork 11 controls the direction of air brown into the passenger compartment of an automobile through the vent assembly. The drawer part 12 has a box-shape, which is opened at its top so as to contain an aromatic, germicide and/or deodorizer therein. This grill unit 1 is movably set in the housing 2 such that the grill unit 1 is ejected from or retracted into the housing 2 within a predetermined range.

In a detailed description of the vent assembly according to the primary embodiment with reference to FIGS. 1a, 1b and 2, this vent assembly “A” consists of the grill unit 1 and the housing 2. The grill unit 1, which consists of the grillwork 11, and the grillwork holder 10 holding the grillwork 11 therein and integrated with the drawer part 12, is movably set in the housing 2 such that the grill unit 1 is ejected from or retracted into the housing 2 within the predetermined range by the sliding means. A stopper 16 is provided on the external surface of the drawer part 12, while a hook 21 is provided on the internal surface of the housing 2. The hook 21 of the housing 2 stops the stopper 16 of the grill unit 1 when the grill unit 1 is ejected from the housing 2, and so the grill unit 1 is prevented from an undesired complete removal from the housing 2.

The drawer part 12 is provided with an air inlet opening 18 at its rear wall 17 for allowing smooth inlet of air from an air conditioning apparatus (not shown). In the present invention, a container 19, used for containing an aromatic 4 therein, may be integrally formed in the drawer part 12 as shown in FIG. 1a. Alternatively, in place of such a container 19, two holders 4a may be provided in the drawer part 12 for directly holding the aromatic 4 in the drawer part 12, as shown in FIG. 3 showing the second embodiment.

Of course, a deodorizer in place of such an aromatic may be contained in the drawer part. In addition, both an aromatic and a deodorizer may be contained in the drawer part.

During an operation of the air conditioning apparatus, fresh air from the air conditioning apparatus passes through the grill unit 1 after flowing through the venting channel and the interior of the housing 2, thus being laden with perfume components of the aromatic 4 when it is discharged into the passenger compartment through the grillwork 11. Therefore, it is possible for this vent assembly to maintain a fresh and pleasant interior atmosphere of the passenger compartment.

The sliding means according to the primary embodiment comprises a rack 14 arranged along the lower surface of the bottom of the drawer part 12. A reduction gear train 32 is installed in the housing 2, and operated in conjunction with a reversible motor 33 of a drive means 3 by means of a power transmission rubber belt 31. This reduction gear train 32 engages with the rack 14 of the drawer part 12, thus moving the grill unit 1 relative to the housing 2 using the power of the motor 33. A movable rail 15 is arranged along the external surface of each of the two sidewalls of the drawer part 12, while a fixed rail 20 is arranged along the internal surface of each of the two sidewalls of the housing 2. The two fixed rails 20 respectively seat the two movable rails 15 thereon so as to guide a linear movement of the movable rails 15 with the drawer part 12 relative to the housing 2.

The drive means 3 comprises the motor 33, the power transmission belt 31 made of rubber, and the reduction gear train 32 consisting of a plurality of reduction gears. This drive means 3 moves the grill unit 1 in opposite directions relative to the housing 2 within the predetermined range, thus ejecting or retracting the grill unit 1 from or into the front end of the housing 2. During an operation of the drive means 3, the rotating power of the motor 33 is transmitted to the reduction gear train 32 through the belt 31. Since the reduction gear train 32 engages with the rack 14, which is arranged along the bottom of the drawer part 12 of the grill unit 1, the gear train 32 linearly moves the rack 14 within the predetermined range to eject or retract the grill unit 1 from or into the housing 2. During a movement of the grill unit 1 to be ejected from the housing 2, the grill unit 1 is prevented from an undesired complete removal from the housing 2 by an engagement of the stopper 16, which is provided on the external surface of the drawer part 12, with the hook 21 which is provided on the internal surface of the housing 2. Therefore, the grill unit 1 may be retracted into the housing 2 from the ejected position to restore its original position without failure.

In the drive means 3, the reduction gear train 32 is operated in conjunction with the motor 33 by means of the power transmission rubber belt 31, and so it is possible for a user to manually eject or retract the grill unit 1 relative to the housing 2 without operating the motor 33 as shown in FIG. 3. Such a manual operation of the grill unit 1 results in the same linear movement of the grill unit 1 relative to the housing 2 as expected from the motor-operated movement.

As shown in FIG. 4 showing the third embodiment, a seating slot 13 may be formed on the upper wall of the grillwork holder 10 of the grill unit 1 so as to removably seat an air filter 5 therein. In such a case, the air filter 5 removes dust from air passing through the grill unit 1, thereby cleaning the air before the air is discharged into the interior of the passenger compartment. This vent assembly thus maintains a fresh, clean and pleasant interior atmosphere of the passenger compartment.

Of course, an aromatic or a deodorizer in place of such an air filter may be seated in the seating slot 13 of the grill unit 1 as desired.

The operational effect of this vent assembly “A” having the above-mentioned grill unit 1 will be described in detail herein below.

In order to install the vent assembly “A” at the dashboard “B” of an automobile, the housing 2 is primarily installed in the end of a venting channel formed in the dashboard. The grill unit 1 is set in the housing 2 such that the two movable rails 15 of the drawer part 12 of the unit 1 are movably seated on the two fixed rails 20, respectively, so as to linearly slide along the fixed rails 20.

When driving the automobile with the air conditioning apparatus operated, fresh air from the air conditioning apparatus passes through the grill unit 1 prior to being discharged into the passenger compartment. In such a case, the air passes by the aromatic 4, and passes through the air filter 5, thus being laden with perfume components of the aromatic 4 and cleaned by the air filter 5. Therefore, this vent assembly supplies fresh, clean and scented air into the passenger compartment, thus maintaining a fresh and pleasant interior atmosphere of said compartment.

When the reversible motor 33 of the drive means 3 is operated in a direction by manipulating a control switch (not shown) connected to the motor 33, the rotating power of the motor 33 is primarily transmitted to the reduction gear train 32 through the power transmission belt 31, and is, thereafter, transmitted to the rack 14 of the grill unit 1 from the reduction gear train 32 engaging with the rack 14. Therefore, the grill unit 1 moves to be ejected from the housing 2 under the guide of the two fixed rails 20, which are arranged along the internal surfaces of the two sidewalls of the housing 2 and movably seat the two movable rails 15, arranged along the external surfaces of the two sidewalls of the drawer part 12, thereon.

When the grill unit 1 is ejected from the front of the housing 2 by a certain length and opens the housing 2 as described above, it is easy to clean a part of the venting channel and the interior of the housing 2. In addition, the existing aromatic 4 inside the drawer part 12 of the grill unit 1 may be easily changed with a new one. When it is desired to return the grill unit 1 from the ejected position to its retracted position inside the housing 2, the motor 33 of the drive means 3 is operated in an inverse direction by manipulating the control switch. In such a case, the ejected grill unit 1 linearly moves into the housing 2 until it restores its retracted position while closing the housing 2. The vent assembly with the retracted grill unit 1 supplies fresh, clean and scented air into the passenger compartment, and maintains a fresh and pleasant interior atmosphere of the compartment as described above.

In accordance with another embodiment of this invention, the grill unit 1 of the vent assembly may be manually ejected or retracted from or into the housing 2 through a one-touch manual action in place of using such a drive means 3. That is, the sliding means of the vent assembly according to the fourth embodiment of FIG. 5a comprises two pinion gears 41, each of which has a shaft 43. The two pinion gears 41 are respectively provided at the external surfaces of the two sidewalls of the drawer part 12, and coupled together by a torsion coil spring 42, which is connected to the two shafts 43 of the two pinion gears 41 at both ends thereof. At the external surface of each sidewall of the drawer part 12, a reduction gear 32a engages with the pinion gear 41 so as to reduce the rotating speed of the pinion gear 41. A movable rail 15 is arranged along the external surface of each sidewall of the drawer part 12 at a position under the pinion gear 41. A rack 14a is arranged along the internal surface of each sidewall of the housing 2. A fixed rail 20 is arranged along the internal surface of each sidewall of the housing 2, and seats the movable rail 15 thereon such that an associated pinion gear 41 engages with the rack 14a and the movable rail 15 is movably placed along a passage defined between the rack 14a and the fixed rail 20. An additional stopper 16-1 is provided at the rear end of the drawer part 12, while a catch 16-1a is provided in the housing 2 for catching or releasing the additional stopper 16-1. This sliding means of FIG. 5a thus allows the grill unit 1 to be manually ejected or retracted from or into the housing 2 through a one-touch manual action.

In a modification of the fourth embodiment, the torsion coil spring 42, shafts 43, pinion gears 41 and reduction gears 32a are installed at a lower portion of the rear section of the drawer part 12 as shown in FIG. 5b. In such a case, the rack 14a is arranged along the internal surface of each sidewall of the housing 2 at a position under the fixed rail 20. In this modification, the two pinion gears 41 provided at both sidewalls of the housing 2 engage with the two racks 14a of the housing 2, respectively, while the movable rail 15 is movably seated along a passage defined between the rack 14a and the fixed rail 20. This modification improves the space efficiency of the drawer part 12, and allows a user to easily receive or remove an aromatic 4 in or from the drawer part 12.

In the above modification, the stopper 16 provided on the external surface of the drawer part 12 is stopped by the hook 21 provided on the internal surface of the housing 2 when the grill unit 1 is ejected from the housing 2. The grill unit 1 is thus prevented from an undesired complete removal from the housing 2.

In the present invention, the sliding means for allowing a user to manually eject or retract the grill unit 1 from or into the housing 2 through a one-touch manual action may be embodied as shown in FIG. 5c. The sliding means of the vent assembly according to the fifth embodiment of FIG. 5c comprises a rack 14 and a movable rail 15 provided along each of the two sidewalls of the drawer part 12 such that the rack 14 is positioned above the movable rail 15. A fixed rail 20 and a reduction gear 32b are provided on the internal surface of each sidewall of the housing 2, and respectively engage with the movable rail 15 and the rack 14. An actuating lever 46 is hinged to a support rod 45 installed at the bottom surface of the housing 12, with a torsion coil spring 42a fitted over the rod 45 and normally biasing the actuating lever 46 in a direction where the grill unit 1 is drawn out. An additional stopper 16-2 is provided at the rear end of the drawer part 12, while a catch 16-2a is provided in the housing 2 at a rear position for catching or releasing the additional stopper 16-2. This sliding means allows a user to manually eject or retract the grill unit 1 from or into the housing 2 within a predetermined range through a one-touch manual action.

In the fifth embodiment, the rack 14, the movable rail 15, and the fixed rail 20 are curved at a radius of curvature to form an arcuation, and so the grill unit 1 arcuately slides such that the grillwork holder reaches a lower position in front of the dashboard when the grill unit 1 is ejected from the housing 2 as shown in the drawing. It is thus easy to use the drawer part 12 of the grill unit 1.

In this fifth embodiment, the grill unit 1 of the vent assembly is designed to be manually ejected or retracted from or into the housing 2 through a one-touch manual action in place of using a drive means 3.

In the vent assembly of this invention, two or more grill units 1 may be installed in the housing 2 as shown in FIG. 6 such that the grill units 1 are independently ejected from or retracted into the housing 2.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### Industrial Applicability

As described above, the present invention provides a vent assembly with a drawer-type grill unit for automobiles. The drawer-type grill unit is designed such that it is appropriately ejected from or retracted into a housing installed in the dashboard. In the vent assembly, the grill unit slides relative to the housing by a motor operation or a manual operation within a predetermined range capable of preventing an undesired complete removal of the grill unit from the housing. A user is thus allowed to selectively eject or retract the grill unit from or into the housing, and to open the housing when it is desired to clean the grill unit and the interior of the housing. This vent assembly also has a drawer part at the rear section of the grill unit to contain a desired material, such as an aromatic or a deodorizer, in the drawer part, with an air filter removably seated in a seating slot which is formed at the upper wall of the grillwork holder of the grill unit. The vent assembly thus blows fresh, clean and scented air into the passenger compartment, and maintains a fresh and pleasant interior atmosphere of the passenger compartment of an automobile.

1. A vent assembly for automobiles, comprising a grill unit and a housing, wherein
said grill unit consists of a grillwork, and a grillwork holder holding said grillwork therein and integrated with a drawer part, said grill unit being movably set in said housing such that the grill unit is ejected from or retracted into the housing within a predetermined range by sliding means, with a stopper provided on an external surface of said drawer part and a hook provided on an internal surface of said housing, whereby said stopper is stopped by said hook when the grill unit is drawn out, and so the grill unit is prevented from an undesired complete removal from said housing.

2. The vent assembly according to claim 1, wherein said sliding means comprises:
a rack arranged along a lower surface of a bottom of said drawer part;
a reduction gear train installed in said housing and operated in conjunction with a motor by means of a power transmission belt, said reduction gear train engaging with said rack;
a movable rail arranged along an external surface of each of two sidewalls of said drawer part; and
a fixed rail arranged along an internal surface of each of two sidewalls of said housing, and seating said movable rail thereon so as to guide a movement of said movable rail with the drawer part relative to the housing.

3. The vent assembly according to claim 1, wherein said sliding means comprises:
two pinion gears each having a shaft, and respectively provided at two sidewalls of said drawer part, and coupled together by a torsion spring, said torsion spring being connected to the shafts of said pinion gears at both ends thereof;
a reduction gear engaging with each of the two pinion gears;
a movable rail arranged along an external surface of each of two sidewalls of said drawer part at a position under an associated pinion gear;
a rack arranged along an internal surface of each of two sidewalls of said housing;
a fixed rail arranged along the internal surface of each sidewall of said housing, and seating said movable rail thereon such that an associated pinion gear engages with the rack and the movable rail is movably placed along a passage defined between the rack and the fixed rail;
an additional stopper provided at a rear end of said drawer part; and
a catch provided in said housing for catching or releasing the additional stopper.

4. The vent assembly according to claim 3, wherein the torsion spring, shafts, pinion gears and reduction gears are installed at a lower portion of a rear section of said drawer part, and said rack is arranged along the internal surface of each sidewall of said housing at a position under the fixed rail.

5. The vent assembly according to claim 1, wherein said sliding means comprises:
a rack and a movable rail provided along each of two sidewalls of said drawer part such that the rack is positioned above said movable rail;
a fixed rail and a reduction gear provided on an internal surface of each sidewall of said housing, and respectively engaging with the movable rail and the rack;
an actuating lever hinged to a support rod installed at a bottom surface of said housing, with a torsion spring fitted over said rod and normally biasing the actuating lever in a direction where the grill unit is drawn out;
an additional stopper provided at a rear end of said drawer part; and
a catch provided in said housing at a rear position for catching or releasing the additional stopper.

6. The vent assembly according to claim 1, wherein two or more grill units are installed in the housing such that the grill units are independently ejected from or retracted into the housing.

7. The vent assembly according to claim 1, wherein a container is integrally formed in said drawer part.

8. The vent assembly according to claim 1, wherein a seating slot is formed on an upper wall of the grillwork holder of said grill unit so as to seat an air filter therein.

9. The vent assembly according to claim 1, wherein a holder is provided in said drawer part for holding an aromatic in the drawer part.
